(19) United States
(12) Patent Application Publication
(10) Pub. No.: US 2017/0130173 A1
(43) Pub. Date: May 11, 2017

(54) METHOD FOR REMOVING RUST FROM A SURFACE

(71) Applicant: RUSTYCO, Wildervank (NL)

(72) Inventor: Louis OTTENS, Wildervank (NL)

(21) Appl. No.: 15/319,661

(22) PCT Filed: Jun. 12, 2015
(86) PCT No.: PCT/NL2015/050436

§ 371 Date: Dec. 16, 2016

(30) Foreign Application Priority Data
Jun. 17, 2014 (NL) 2013010

(51) Int. Cl. C11D 11/00; C11D 1/66; B08B 3/12; C23G 1/08; B08B 3/08; C11D 3/34; C23G 5/06

(52) U.S. Cl. CPC C11D 11/0029; C11D 3/3472; C11D 1/66; C23G 5/06; C23G 1/088; B08B 3/08; B08B 3/12

(57) ABSTRACT

Described is a method for removing rust from a rusted surface comprising the steps of a) applying to the said surface a first composition comprising a penetrating oil, and b) applying to the said surface a second composition comprising at least one thiol compound, the thiol compound being a thiol substituted carboxylic acid, or a salt or alkyl ester thereof, wherein step b) is carried out prior to, or subsequent, to step a), a kit comprising said first and second compositions, a composition and also to the use of said composition for rust removal.

The invention relates to a method for removing rust from a rusted surface, a kit for use in said method, a composition and the use of the composition for removing rust from a surface.

In the art, many methods for removing rust are known. For example, rust can be removed from surfaces manually, e.g. by using abrasive paper or a steel brush. However, the surface is often damaged by such manual treatment. Using a machine does not solve said problem.

Also, chemical rust removers are known in the art, that result in chemical conversion of the rust, avoiding the above surface damage. U.S. Pat. No. 3,623,983 describes a penetrating oil comprising mono- and di-esters of phosphoric acid for removal of rust from surfaces and fixtures and fittings such as screws and bolts. The use of phosphoric acids in rust dissolver compositions however has the disadvantage that such mixtures pose health and safety risks to the user.

The term “penetrating oil” is known to the skilled person. It is known as a lubricant with a relatively low viscosity and a high surface tension, which seeps into relatively small areas by capillary action thereby creating room between screws and bolts. Penetrating oil consists mostly of oils, for example mineral oil or silicon oil, and encompass petroleum oil compositions comprising one or more petroleum derived products selected from the group consisting of C1-C40 aliphatic hydrocarbons, light naphthenic petroleum distillates, medium naphthenic petroleum distillates, heavy naphthenic petroleum distillates, petroleum distillates, mineral oils and one or more additives chosen from the group of petroleum waxes, carbon dioxide, fatty acids, C3-C20 hydrocarbon ethers, and inorganic acids.

GB 976273 discloses a composition for preventing or removing tarnish on metals by bringing them into contact with a composition comprising penetrating oil, certain thiol compounds and an organic solvent. Thiol compounds are known to convert rust, i.e. insoluble iron oxides, into soluble ferrous ions, resulting in a colour change. Following application of the thiol compound to a rusted surface, a colour change from colourless to purple takes place and so the removal of rust can be visually followed. The purple colour change may be due to the reaction of the thiol compound with ferrous oxides whereby the purple coloured ferrothioglycolate ion, Fe(SCH₂COO)₂²⁻, is formed. The purple color is easily distinguishable from the typically brown or red iron oxide rust layer on iron containing surfaces.

It is an object of the present invention to provide a method for improving the removal of rust from a rusted surface.

The inventors have surprisingly found a solution to this problem by providing a process for the removal of rust from a rusted surface comprising the steps of:

a) applying to the said surface a first composition comprising a penetrating oil,

b) applying to the said surface a second composition comprising at least one thiol compound, being a thiol substituted carboxylic acid, or a salt or alkyl ester thereof, wherein step b) is carried out prior to or subsequent to step a).

It has been surprisingly found that the removal of rust occurs faster using the method of the present invention than when a thiol compound or a penetrating oil are applied as a single composition as described in GB976273. Without being bound to any explanation, it is believed the thiol compound in the penetrating oil composition adversely affects the lubricating properties of the penetrating oil.

It was a contemplation of the inventors to apply the penetrating oil separately from the thiol compound, in order to allow the penetrating oil to seep into cracks in the rusted surface and therewith to improve the subsequent accessibility of the thiol compounds in order to improve the rust removing activity. In so doing, the thiol compound appeared to be drawn more quickly and deeper into the rusted surface thus enhancing the rust removal effect, compared to when both reagents are applied simultaneously in one composition.

Surprisingly, it has been found that an improved rust removal is also obtained when the thiol compound is applied before the penetrating oil. In this case the mechanism for enhancing the rust removal effect cannot be explained as above. It is, however, postulated that following application of the thiol compound, the thiol compound reacts chemically with the metal oxide layer, thus breaking up the oxide layer, so that the subsequently applied penetrating oil seeps into the ‘holes’ in the oxide layer made by the thiol compound. Consequently an improved rust removal is achieved, compared to when a thiol compound and/or a penetrating oil are applied as a single composition.

By ‘subsequently’ is meant that both the penetrating oil and thiol compound are applied from different compositions so there is some time between applying them, such as at least 5 seconds, preferably at least 15, more preferably at least 30 seconds, e.g. 1 or 2 minutes. Longer periods, e.g. up to 10 minutes or more are possible. Preferably, the time period does not allow the applied composition to dry out before applying the next composition. It has been found that by allowing a period of time between applying the two compositions as indicated to lapse, an improved rust removal is achieved. Such an improvement is observed even when there is only a few seconds between applying the first and second compositions. A particularly good result is achieved when 30 seconds to 1 minute elapses between applying the first and second compositions.

The first composition may comprise 100 wt. % penetrating oil or less. It may e.g. comprise other additives such as fragrances and emulsifiers. Preferably, the first composition comprises at least 50 w/w %, with respect to the total weight of the said first composition, penetrating oil, preferably at least 70 w/w % or more.

The method according to the present invention has a further advantage that the thiol compound can be used to remove rust in combination with any penetrating oil to improve the removal of rust. Moreover, the amounts of the thiol compound used relative to the penetrating oil can be varied as necessary according to the amount of rust present.

For a particularly effective rust removal at least 1 wt. %, preferably at least 10 wt. %, more preferably 20 wt. % thiol compound with respect to the weight of the penetrating oil is applied. For example, at a specific area where a relatively large intensity of rust is found, considerably more thiol compound can be used than on areas which have less rust. When at least 20 wt. % thiol compound is used an exceptionally quick rust removal is observed on areas which have a high concentration of rust.

The present method is suited to remove rust from any rusted surface. The term “rusted” means any metal oxide layer present on a surface, the surface being for example metal surfaces such as, aluminium, brass, chromium, copper, gold, iron, silver, zinc and mixtures and alloys thereof, for example stainless steel. The term “surface” includes fixtures such as screws, bolt, nuts, nails and pins and any other material, such as plastics or concrete, which comprises oxidized metal surfaces.

The first composition and second composition can be applied in several different ways, for example it can be applied by spraying, manually with a cloth or brush. Preferably, both the first and second compositions are individually applied from independent spray cans or nebulisers.

The removal of rust can be accelerated by applying a mechanical force for example by abrasion using a sponge, brush or other such tools which aid in dislodging particles adhered to the surface. Vibrations can also be used to remove rust and such vibrations can be induced by, for example, ultrasound.

Optionally, an additional washing step c) is carried out after application of the first and second compositions. In said washing step the dislodged particles and dissolved rust can be removed from the surface, resulting in a clean, de-rusted surface with a refreshed appearance.

In a preferred embodiment the reactive thiol compound has a structure according to formula (I) or formula (II):

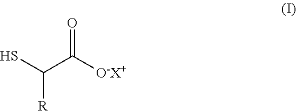

wherein R is hydrogen or methyl and X⁺ is hydrogen or an alkali metal cation or alkali earth metal cation or an ammonium or substituted ammonium cation, preferably lithium cation, sodium cation, potassium cation or ammonium ion.

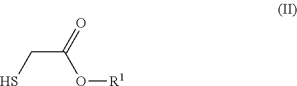

where R¹ is a cyclic, linear or branched alkyl, substituted or unsubstituted, with having 1-22 carbon atoms.

The compounds according to claim 1 are thiol substituted carboxylic acids or salts thereof. The compounds according to formula (II) are thioglycolate alkyl esters. The synthesis of such compound is known and such compounds are commercially available.

Preferred thiol compounds are thioglycolic acid (mercapto acetic acid), or sodium thioglycolate. These compounds have particularly good rust removing effects in combination with commonly commercially available penetrating oils such as WD-40.

Preferably the thiol compound is sodium thioglycolate. The inventors have found that when sodium thioglycolate is used rust is quickly removed from the surface. Furthermore, the pH of sodium thioglycolate is between 6.8 and 7 meaning that such compositions are pH neutral and therefore pose fewer safety risks for the user than strongly acidic thiol compounds such a thioglycolic acid (pH 1). Moreover, using sodium thioglycolate is advantageous as there is also no need to optimize the pH of the thiol compound a particular surface, unlike in combined penetrating oil and thiol compound compositions of the prior art. When the second composition comprises sodium thioglycolate, there is no need for such alkane pH, making the method according to the invention safer than that of the prior art.

In a preferred embodiment, second composition is an aqueous composition, wherein the aqueous composition comprises between 0.1 and 50 wt. %, preferably between 1 and 40 wt. %, more preferably between 5 and 30 wt. % most preferably between 10 and 20 wt. %, thiol compound with respect to the total weight of the composition.

A water-based composition has the advantage that it is more environmentally friendly and safer to use than a composition based on an organic solvent-based composition. Compositions with a particularly high weight percentage, for example between 40 and 50 wt. % of thiol compound are particularly suited to surfaces with considerable areas of rust. It has been found, however, that even relatively low concentrations of thiol compound, for example between 10 and 20 wt. % can be used to achieve a surface free of rust.

In a preferred embodiment of the method of the invention, the first and/or second composition comprise(s) an emulsifier. The inventors have found that the addition of an emulsifier to the thiol compound and/or the penetrating oil compositions improves the in situ mixing of the two components on the rusted surface. As a result and an improved rust removal effect is obtained

By ‘emulsifier’ is meant a surface active agent that stabilizes an oil-in-water or water-in-oil mixture. The inventors have found that using a penetrating oil in which an emulsifier is present facilitates the in situ mixing of the thiol compound with the penetrating oil on the metal surface, and therewith the accessibility of the thiol compound, further improving the rust removing effects of the present method. To this end, the first composition preferably comprises between 0.1 and 30 wt. %, more preferably between 1 and 20 wt. % and even more preferably between 5 and 10 wt. % of an emulsifier with respect to the total weight of the first composition.

At above 30 wt. % the lubricating properties of the penetrating oil are significantly altered. It has been found that using less than 30 wt. % is desirable in order to achieve an improved rust removal. Similarly, at amounts of less than 0.1 wt. % emulsifier no improved mixing with the thiol compound is observed. The optimal range for the emulsifier lies between 5 and 10 wt. % as in this range the lubricating properties of the penetrating oil are retained while an optimum mixing with the thiol compound is observed, resulting in an improved rust removal.

In another embodiment, the second composition comprises an emulsifier. To this end, the second composition preferably further comprises between 0.1 and 20 wt. %, more preferably between 0.5 and 15 wt. %, even more preferably between 1 and 10 wt. % and most preferably between 2 and 8 wt. % of an emulsifier with respect to the total weight of the second composition.

It is particularly advantageous if an emulsifier is present in the composition comprising the thiol compound. Surprisingly, it has been found that inclusion of an emulsifier in only the thiol compound gives an improved rust effect. This is believed to be due to the uniform distribution of the thiol compound in the aqueous composition. The upper limit for the amount of emulsifier has been found to be 20 wt. % whereas at below 0.1 wt. % no advantageous effect of inclusion of the emulsifier was seen. The best rust removal was observed when between 2 and 8 wt. % emulsifier was added to the second composition.

In a preferred embodiment, the emulsifier is selected from the group consisting of polyethylene glycol ethers, primary alcohol ethoxylates, alkyl diglycols and combinations thereof, preferably primary alcohol ethoxylates. The inventors have found that polyethylene glycol ethers, primary alcohol ethoxylates and alkyl diglycols are suitable for using in the method according to the invention. Primary alcohol ethoxylates are particularly preferred due to the absence of side reactions with the thiol compound or penetrating oil.

In another preferred embodiment, the primary alcohol ethoxylate is selected from the group of primary alcohol ethoxylates having C9-C17 alcohol group and between 3 and 8 moles of ethoxylate, preferably having between 9 and 11 carbon atoms and between 5 and 6 moles of ethoxylate. For example Neodol (supplier: Shell) type emulsifiers are particularly suitable as these do not adversely effect the stability of the thiol compounds in the second composition. It has been found that synthetic primary alcohol type emulsifiers (e.g. Ethylan, supplier: AkzoNobel) may reduce the stability of the second composition on storage.

Preferably the emulsifier has a hydrophilic/lipophilic balance (HLB) of between 1 and 18 according to the Griffin index, preferably between 1 and 10 and most preferably between 1 and 5. Emulsifiers with an HLB of between 1 and 5 were found to improve the in situ mixing of the first and second compositions, when either or both compositions contained such emulsifiers.

When the second composition is an aqueous composition, it is particularly preferred that the emulsifier has an HLB of between 1 and 5 because this not only stabilizes the second composition by dispersing the thiol compound in the aqueous phase, but also improves the mixing of the first composition, an oil phase, with aqueous second composition and thus leading to an improved rust removal.

A HLB value of between 1 and 5 is typical for a water-in-oil emulsifier. The emulsifier ensures that the water disperses in oil. The emulsifier preferably has a non-ionic character. For example suitable emulsifiers include but are not limited to mono- and di-glycerides, sorbital esters, polyethylene sorbitan fatty esters, polyethylene sorbitol esters, polyethylene alcohols, primary alcohol ethoxylates and mixtures thereof. Preferably a mixture of emulsifiers is used.

In another embodiment, the emulsifier has a hydrophilic/lipophilic balance (HLB) of between 5 and 8 according to the Griffin index. This is advantageous in order to achieve a particularly high surface wetting for applications when it is necessary to provide a layer of the first and second compositions on a surface with a considerable amount of rust.

In an embodiment, the emulsifier has a hydrophilic/lipophilic balance (HLB) of between 8 and 10 according to the Griffin index. This has the advantage that the emulsifier also functions as a detergent, further providing an added cleaning effect.

In another embodiment, the emulsifier has a hydrophilic/lipophilic balance (HLB) of between 10 and 12 according to the Griffin index. This is particularly favoured when the second composition is predominantly an organic phase as such emulsifiers stabilize oil-in-water emulsions.

In yet another embodiment, the emulsifier has a hydrophilic/lipophilic balance (HLB) of between 12 and 18 according to the Griffin index. At such high HLB values, the emulsifier acts as a solubilizer for particularly insoluble impurities that may also be present on the rusted surface, thus improving the rust removal on surfaces with high concentrations of rust.

The Griffin index is according to W. C. Griffin, “Classification of Surface-Active Agents by ‘HLB,’” Journal of the Society of Cosmetic Chemists, 1 (1949): 311; and W. C. Griffin, “Calculation of HLB Values of Non-Ionic Surfactants,” Journal of the Society of Cosmetic Chemists, 5 (1954): 259).

Optionally one or more fragrances can be added to the thiol compound. The smell of thioglycolic acid or thioglycolate esters can be masked by one or more additives chosen from the group consisting of benzyl ortho hydroxy benzoate, 3,7-dimethyl-6-octene-1-ol, 2,6-dimethyl-7-octene-2-ol, α, α-dimethyl phenethyl butyrate, 3,7-dimethyl-1,6-nonadiene-3-ol, 1,3,4,6,7,8-hexahydro-4,6,6,7,8,8-hexamethyl-cyclopenta-γ-2-b, trans-3,7-dimethyl-2,6-octadiene-1-ol, hexyl cinnamic aldehyde, alpha n-hexyl ortho hydroxy benzoate, 1-(1,2,3,4,5,6,7,8-octahydro-2,3,8,8-tetramethyl-2-naphthalenyl)ethanone, p-tert-butyl-α-methyldihydrocinnamic aldehyde-limonene, linalol and hydroxy methyl pentyl cyclohexene carbaldehyde. These and other suitable fragrances can be combined to a perfume which in sufficiently high concentrations masks the somewhat inconvenient smell of thioglycolate compounds.

In a second aspect, the present invention relates to a kit for performing a method for removing rust from a surface, wherein the kit comprises:

a) a first holder comprising a first composition as defined above,
b) a second holder comprising a second composition as defined above.

The kit according to the present invention has the advantage that each of the two reagents, the penetrating oil and thiol compound, can be individually dosed onto the surface to be treated. Surprisingly, applying the first and second compositions separately leads to an improved removal of rust compared to using a single composition that comprises both penetrating oil and thiol compound, as discussed earlier. Furthermore, the shelf life of the kit according to the present invention is longer than that of a combined penetrating oil/thiol compound product due to the lack of possible side reactions between the thiol compound and penetrating oil that would occur between both components when formulated in a single composition on storage, resulting in loss of activity of the thiol compound over time. Moreover the user of the kit is able to apply the penetrating oil and thiol compound separately and in desired relative quantities to the rusted surface as explained above. This has the added advantage that an improved rust removal is obtained.

In a third aspect, the present invention relates to a composition comprising between 0.1 and 50 wt. % of a thiol compound as defined above, between 0.1 and 20 wt. % of an emulsifier and further comprising between 30 and 99.8 wt. % water with respect to the total weight of the composition, wherein the emulsifier is selected from the group consisting of polyethylene glycol ethers, primary alcohol ethoxylates alkyl diglycols and combinations thereof.

It has been found that a composition comprising between 0.1 wt. % and 50 wt. % of a thiol as defined in formulas (I) and (II) can be stabilised using an emulsifier selected from the group of polyethylene glycol ethers, primary alcohol ethoxylates and alkyl diglycols and combinations thereof. Not only does such a composition have a long shelf life due to the lack of cross reactivity between these specific emulsifiers and thiol compounds, the composition accelerates the removal of rust when applied either before or after a penetrating oil composition to a rusted surface.

In a preferred embodiment, the thiol compound is thioglycolic acid or sodium thioglycolate, preferably sodium thioglycolate.

The inventors have found that sodium thioglycolate leads to a particularly effective rust removal at neutral pH. This has the further advantage of fewer health and safety risks than thioglycolic acid (pH 1).

In an embodiment, the composition further comprises between 0.5 and 15 wt. %, preferably between 1 and 10 wt. %, more preferably between 2 and 8 wt. % emulsifier with respect to the total weight of the composition.

It has been found that the optimum weight percentage of emulsifier is between 2 and 8 wt. % with respect to the total weight of the composition.

In an embodiment, the emulsifier is selected from the group of primary alcohol ethoxylates having a C9-C17 alcohol group and between 3 and 8 moles of ethoxylate, preferably having between 9 and 11 carbon atoms and between 5 and 6 moles of ethoxylate. These emulsifiers are particularly preferred because of the long term stability in the presence of thiol compounds.

In an embodiment, wherein the emulsifier has hydrophilic/lipophilic balance (HLB) of between 1 and 18 according to the Griffin index, preferably between 1 and 10, more preferably between 1 and 5. An emulsifier with an HLB of between 1 and 5 is particularly suited to improving the in situ mixing of an aqueous composition comprising a thiol compound and the penetrating oil.

In a fourth aspect, the present invention relates to the use of a composition for the removal of rust from a surface. In particular when the surface has been treated with a penetrating oil composition or is to be treated with a penetrating oil composition, subsequent to the use of the thiol compound.

It has been surprisingly found that by applying a thiol compound in an aqueous composition comprising an emulsifier selected from the group polyethylene glycol ethers, primary alcohol ethoxylates and alkyl diglycols and combinations thereof, prior to, or subsequent to, the application of a penetrating oil to a rusted surface, an acceleration in the removal of rust from a rusted surface is obtained.

The invention is further explained using the following non-limiting examples.

### Penetrating Oil Composition (P)

The penetrating oil used (WD-40, WD-40 Company, San Diego, Calif., USA) in the comparative examples 1-6 and examples 1-9 has the following composition:

TABLE 1
Penetrating oil composition (P)

| Component | Cas. no. | Weight percept |
|---|---|---|
| Aliphatic | 64742-47-8 | 45-50 |
| Hydrocarbon | | |
| Petroleum Base Oil | 64742-56-9 | <25 |
| | 64742-65-0 | |
| | 64742-53-6 | |
| | 64742-54-7 | |
| | 64742-71-8 | |
| LVP Aliphatic | 64742-47-8 | 12-18 |
| Hydrocarbon | | |
| Carbon Dioxide | 124-38-9 | 2-3 |
| Non-Hazardous | Ingredients Mixture | <10 |

### COMPARATIVE EXAMPLE 1

The compatibility of different organic acids was tested with commercially available penetrating oil composition (P). In the following example the acids and WD-40 were mixed in a ratio of 1:1 in a test tube and shaken for 5 minutes. 1 minute after shaking the mixtures were visually inspected, wherein + means a stable mixture and − means that phase separation was observed.

Subsequently, the rust removing effect of the tested organic acid-penetrating oil mixtures was studied, after 5 minutes of applying the mixture to an oxidized steel test plate (2 cm×5 cm). + means that after 5 minutes rust removal was observed, whereas − means that a minimal/no rust removal was observed.

TABLE 2
Compatibility of organic acids with penetrating oil

| | Mixing ability | |
|---|---|---|
| Acid | with WD-40 | Rust removal |
| Hydrochloric | − | − |
| acid, Sigma | | |
| Aldrich (Cas | | |
| No 7647-01-0) | | |
| (10 wt. %) | | |
| Citric acid, | + | − |
| Sigma Aldrich | | |
| (Cas No 77- | | |
| 92-9) (10 wt. | | |
| %) | | |
| Phosphoric | − | − |
| acid, Sigma | | |
| Aldrich (Cas | | |
| no. 7664-38-2) | | |
| (10 wt. %) | | |
| Formic acid, | − | − |
| Sigma Aldrich | | |
| (Cas No 64- | | |
| 18-6) (10 wt. | | |
| %) | | |
| Oxalic acid, | − | − |
| Sigma Aldrich | | |
| (Cas. No 144- | | |
| 62-7) (10 wt. | | |
| %) | | |
| Thioglycolic | + | + |
| acid, Sigma | | |
| Aldrich (Cas | | |
| No 68-11-1) | | |
| (10 wt. %) | | |
| Sodium | + | + |
| thioglycolate | | |
| 46%, Sigma | | |
| Aldrich (367- | | |
| 51-1) (10 wt. | | |
| %) | | |

With respect to thioglycolic acid it was observed that this compound slowly gave a purple colour in the presence of rust. For the other acids there was no clear visual indication of a rust removal effect.

### COMPARATIVE EXAMPLE 2

The penetrating oil composition (P) was mixed with sodium thioglycolate and water according to the weight percentages given in the table below. The sodium thioglycolate (powder) appeared to mix well with the penetrating oil. No colour change was observed.

TABLE 3
Penetrating oil and thioglycolate composition

| Component | Amount/weight percent |
|---|---|
| Penetrating oil (P) | 60 |
| Sodium thioglycolate | 20 |
| Water | 20 |

The mixture of sodium thioglycolate in water and penetrating oil, separation of the mixture was observed immediately after mixing.

### COMPARATIVE EXAMPLE 3

TABLE 4
Penetrating oil and thioglycolate composition with an
emulsifier

| Component | Amount/weight percent |
|---|---|
| Penetrating oil (P) | 70 |
| Sodium thioglycolate | 10 |
| Water | 20 |
| Ethylan 1005 (AkzoNobel) | 10 |

TABLE 5
Penetrating oil and thioglycolate composition with an
emulsifier

| Component | Amount/weight percent |
|---|---|
| Penetrating oil (P) | 70 |
| Sodium thioglycolate | 10 |
| Water | 20 |
| Marlipal O13/30 (SASOL) | 10 |

Ethylan 1005 and Marlipal O13/30 were used as emulsifiers. Ethylan 1005 is a non-ionic surfactant based on a synthetic primary alcohol (technical data sheet, 18 Aug. 2011, AkzoNobel). Marlipal O13/30 is a surfactant based on alkylpolyethylene glycol ethers (technical data, Sasol Olefins & Surfactants, Isotrideconal Ethoxylates Marlipal 013). In both cases a discolouration was observed, which is an indication for a chemical reaction of the thioglycolic acid with the emulsifier. Furthermore, separation of the mixtures was observed.

### EXAMPLE 1

In a further test system, a mixture of thioglycolic acid, sodium thioglycolate and emulsifiers in water was prepared, in the absence of a penetrating oil composition.

TABLE 6
Thioglycolate composition with an emulsifier

| Component | Amount |
|---|---|
| Calstar, Sigma | 27 |
| Aldrich, Cas. No | |
| 7757-93-9, | |
| Risella olie X 420. | 46 |
| Shell (refined | |
| mineral oil, | |
| paraffinic) | |
| Rokanol, PCC- | 5 |
| Exol, (C13 Iso, | |
| Alcohol + 12 EO) | |
| Sodium | 5 |
| thiolglycolate, | |
| Thioglycolic acid | 5 |
| Butylglycol (Cas | 2 |
| No. 111-76-2) | |
| Water | >100% |

This led to a compatible mixture that did not show any discolouration on standing. The mixture remained homogenous on standing for at least 5 minutes after shaking, which is sufficient time to apply mixture to a surface and for the homogenous mixture to seep into the surface by capillary action. Although this composition is stable, the pH of this solution was about pH 1, which was deemed to pose a health and safety risk for the user. Consequently, a different composition was investigated, as shown in Example 2.

### EXAMPLE 2

A rusted steel plate (2 cm×5 cm) was sprayed with 5 mL of a penetrating oil composition (P), after 1 minute 1 mL of a reactive thiol compound was applied, according to the table below:

TABLE 7
Thioglycolate composition with an emulsifier

| Component | Amount/weight percentage |
|---|---|
| Sodium thioglycolate | 20 |
| Marlipal O13/30, SASOL | 10 |
| Water | 66 |
| Neodol 91/6E (C9-C11 NEODOL | 2 |
| alcohol with an average of | |
| approximately 6 moles of ethylene | |
| oxide per mole of alcohol), Shell | |
| Butyldiglycol, Sigma Aldrich, (CAS | 2 |
| no. 112-34-5) | |

The thioglycolate solution appeared to mix slowly with the penetrating oil present on the test plate, which was apparent due to the slow speed with which the purple colour appeared. The rust was effectively removed from the surface of the test plate.

### EXAMPLE 3

A penetrating oil composition according to comparative example 1 was mixed with Marlipal O13/30 emulsifier (10 wt. %). The penetrating oil composition comprising the emulsifier was added to a steel test plate (2 cm×5 cm). Subsequently, the thioglycolate composition according to example 2 was applied to the test plate. A colour change from clear to purple occurred more quickly than when no emulsifier was present in the penetrating oil (i.e. example 2). Addition of an emulsifier to the penetrating oil appears to produce a better mixture of the penetrating oil and thioglycolate solution. Consequently, the thioglycolate solution seeps more quickly into difficult to reach places in order to remove rust and thus to loosen rusted fixings such as screws and bolts.

### EXAMPLE 4

A further thioglycolate solution was prepared according to table 8. The pH of this solution was 6.5

TABLE 8
Thioglycolate composition

| | Amount/ |
|---|---|
| Component | weight percent |
| Sodium | 20 |
| thioglycolate | |
| Water | 76 |
| Neodol 91/6E | 2 |
| Butyldiglycol | 2 |

A rusted steel test plate (2 cm×5 cm) was covered with penetrating oil composition (P, 5 mL) and then 0.1 or 1.0 mL of the thioglycolate solutions was applied (examples 5, 6 & 8, table 9). Alternatively, the thioglycolate solution was applied first followed by penetrating oil composition (P, examples 7 and 9).

TABLE 9
Comparison of rust removal methods according to the invention and
controls

| | | | Result | Result |
|---|---|---|---|---|
| | | | after 2 | after 15 |
| Example | Step a) | Step b) | minutes | minutes |
| Comparative | Sodium | − | − | − |
| example 2 | Thioglycolate | | | |
| | & penetrating | | | |
| | oil (P) | | | |
| Comparative | Sodium | − | − | + |
| example 3A/B | thioglycolate | | | |
| | & penetrating | | | |
| | oil (P) | | | |
| | [+emulsifier] | | | |
| Comparative | Sodium | − | − | − |
| Example 4 | thioglycolate | | | |
| | solution (46%) | | | |
| Comparative | Sodium | − | − | − |
| Example 5 | thioglycolate | | | |
| | powder (5 g) | | | |
| Comparative | Penetrating oil | − | − | − |
| example 6 | (P)/5 mL | | | |
| Example 5 | Penetrating oil | Sodium | + | ++ |
| | (P)/5 mL | thioglycolate | | |
| | | solution 46%/ | | |
| | | 5 mL | | |
| Example 6 | Penetrating oil | Solution | +++ | +++ |
| | (P)/5 mL | according to | | |
| | | example 4/1 mL | | |
| Example 7 | Solution | Penetrating oil | +++ | +++ |
| | according to | (P)/1 mL | | |
| | example 4/ | | | |
| | 5 mL | | | |
| Example 8 | Penetrating oil | Solution | +++ | +++ |
| | (P)/5 mL | according to | | |
| | | example 4/ | | |
| | | 0.1 mL | | |
| Example 9 | Solution | Penetrating oil | +++ | +++ |
| | according to | (P)/0.1 mL | | |
| | example 4/ | | | |
| | 5 mL | | | |

−: no rust removal observed;
+: partial rust removal;
++: intermediate rust removal;
+++: complete rust removal

The results show that applying sodium thioglycolate separately to the penetrating oil composition leads to rust removal on a rusted surface (example 5) compared to treatment with sodium thioglycolate separately or penetrating oil alone. The rust removal can be accelerated when the sodium thioglycolate solution comprises an emulsifier (examples 6-9) relative to a composition comprising thioglycolate and penetrating oil (comparatives examples 2, 3A and 3B).

1-21. (canceled)

22. A method for removing rust from a rusted surface comprising the steps of:
a) applying to the said surface a first composition comprising a penetrating oil,
b) applying to the said surface a second composition comprising at least one thiol compound, the thiol compound being a thiol substituted carboxylic acid, or a salt or alkyl ester thereof, wherein step b) is carried out prior to, or subsequent, to step a).

23. The method of claim 22, wherein the thiol compound has a structure according to formula (I): 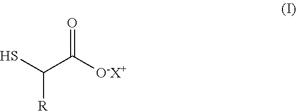
wherein R=hydrogen or methyl, and X⁺ is hydrogen or an alkali metal cation or an alkali earth cation or an ammonium or substituted ammonium cation, preferably X⁺ is lithium cation, sodium cation, potassium cation or ammonium cation.

24. The method of claim 22, wherein the thiol compound has a structure according to formula (II): 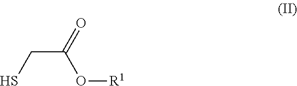
wherein R¹ is a cyclic, linear or branched alkyl, saturated or unsaturated with 1-22 carbon atoms.

25. The method of claim 23, wherein the thiol compound is thioglycolic acid or sodium thioglycolate.

26. The method of claim 22, wherein the second composition is an aqueous composition, wherein the aqueous composition comprises between 0.1 and 50 wt. % thiol compound with respect to the total weight of the composition.

27. The method of claim 22, wherein at least 1 wt. % thiol compound with respect to the weight of penetrating oil is applied.

28. The method of claim 22, wherein the step a) is carried out before step b).

29. The method of claim 22, wherein the first and/or second composition comprise(s) an emulsifier.

30. The method of claim 29, wherein the first composition comprises between 0.1 and 30 wt. % emulsifier with respect to the total weight of the first composition.

31. The method of claim 29, wherein the second composition comprises between 0.1 and 20 wt. % emulsifier with respect to the total weight of the second composition.

32. The method of claim 29, wherein the emulsifier is selected from the group consisting of polyethylene glycol ethers, primary alcohol ethoxylates and alkyl diglycols and combinations thereof.

33. The method of claim 32, wherein the primary alcohol ethoxylate is selected from the group of primary alcohol ethoxylates having C9-C17 alcohol group and between 3 and 8 moles of ethoxylate.

34. The method of claim 29, wherein the emulsifier has hydrophilic/lipophilic balance (HLB) of between 1 and 18 according to the Griffin index.

35. A kit for performing the method of claim 22, wherein the kit comprises:
a) a first holder comprising the first composition as defined in claim 22,
b) a second holder comprising the second composition as defined in claim 22.

36. A composition comprising between 0.1 and 50 wt. % of a thiol compound as defined in claim 22, between 0.1 and 20 wt. % of an emulsifier and further comprising between 30 and 99.8 wt. % water with respect to the total weight of the composition, wherein the emulsifier is selected from the group consisting of polyethylene glycol ethers, primary alcohol ethoxylates alkyl diglycols and combinations thereof.

37. The composition of claim 36, wherein the thiol compound is thioglycolic acid or sodium thioglycolate, preferably sodium thioglycolate.

38. The composition of claim 36, wherein the weight percentage of the emulsifier is between 0.5 and 15 wt. % with respect to the total weight of the composition.

39. The composition of claim 36, wherein the weight percentage of the thiol compound is between 1 and 40 wt. % with respect to the total weight of the composition.

40. The composition of claim 36, wherein the emulsifier is selected from the group of primary alcohol ethoxylates having a C9-C17 alcohol group and between 3 and 8 moles of ethoxylate.

41. The composition of claim 36, wherein the emulsifier has hydrophilic/lipophilic balance (HLB) of between 1 and 18 according to the Griffin index.
